(19) United States
(12) Patent Application Publication
(10) Pub. No.: US 2024/0278267 A1
(43) Pub. Date: Aug. 22, 2024

(54) Painting-Agent Conducting Device, Spray Gun, And Assembly

(71) Applicant: Martin Ruda 1. UG (haftungsbeschränkt), kirchheim (DE)

(72) Inventor: Martin Ruda, Kirchheim unter Teck (DE)

(21) Appl. No.: 18/289,764

(22) PCT Filed: Apr. 1, 2022
(86) PCT No.: PCT/DE2022/000034

§ 371 Date: Nov. 7, 2023

(30) Foreign Application Priority Data
May 14, 2021 (DE) 10 2021 002 522.9
Jun. 2, 2021 (DE) 10 2021 002 831.7
Oct. 28, 2021 (DE) 10 2021 005 362.1

(51) Int. Cl. B05B 7/24

(52) U.S. Cl. CPC B05B 7/2478

(57) ABSTRACT

A painting-agent conducting device (1) is releasably engageable with a spray gun (11). Mechanical guide (7) arrangements assure that the device is properly guided into the operative position in engagement with the spray gun body (21). In the operative position the painting-agent conducting device is stably held in engagement with the spray gun and is prevented from undesirable movement relative thereto. The painting-agent conducting device is manually disengageable from the spray gun when desired for cleaning and/or replacement.

### TECHNICAL FIELD

Exemplary arrangements relate to a painting-agent conducting device, a spray gun, and an assembly.

### BACKGROUND

Spray guns with painting-agent conducting devices are known, for example, from WO2018/109625A1 (3M), WO2016/138888 A1 (HSM) and EP 2 726 212 A1 (SATA). These publications correspond respectively to U.S. Pat. Nos. 11,154,884; 10,870,120; and 10,189,037 the disclosure of each of which is incorporated by reference herein in its entirety.

The problem with these types of assemblies made of a spray gun and a painting-agent conducting device is that the painting-agent conducting device should be easy to engage and arrange on the spray gun and should be firmly retained on it and should also be easy to detach again.

All known prior arrangements attempt to achieve this in different ways, whereby, depending on the arrangement, good stability is achieved by using a complicated design, a lot of material, or particularly stable material.

Prior spray gun arrangements may benefit from improvements.

### SUMMARY

The underlying object of the exemplary arrangements described herein is to further develop these types of spray guns such that a particularly good stability is achieved in a simple way. Indeed, this is achieved in some exemplary arrangements using the least amount of materials or inexpensive materials.

It is often important to ensure that the painting-agent conducting device is firmly retained in engagement with the body of the spray gun in all degrees of freedom and may, for example, be brought into and reversibly fixed onto a line or a curved line in one degree of freedom. The fixing may be thereby achieved through clamps, stops, or also, for example, a union nut. The retention in the other degrees of freedom is achieved in some exemplary arrangements by a fixed attachment at contact surfaces. This fixed attachment is carried out during the application and engagement and finally during the fixing, which presses the applied painting-agent conducting device onto a contact surface of the gun.

In some arrangements the painting-agent conducting device is pressed into the correct position by guide surfaces during the application onto the spray gun. As long as the painting-agent conducting device is still loosely introduced, the guide surfaces assist in moving the painting-agent conducting device into a position in which it ultimately finds a stop and is fixed on the spray gun. These guide surfaces may be arranged somewhat obliquely to the optimal application direction, and may function like a funnel in order to optimally center the painting-agent conducting device with respect to the spray gun.

A mechanical guide, which in some arrangements may extend, for example, parallel to any outlet line, guides the painting-agent conducting device, during arrangement on the spray gun, on the path to engagement with a stop on the spray gun. This path may in some arrangements be a line or a curve. The mechanical guide allows the application for engagement and disengagement of the painting-agent conducting device with the spray gun body on this path and prevents a deviation from this path, by means of parallel contact surfaces spaced apart for example.

In some arrangements the mechanical guide is not a one-sided oblique guide surface, but instead functions like a rail or a channel and enables it to guide the painting-agent conducting device, already optimally aligned to the spray gun, on a defined path with respect to the spray gun, until the painting-agent conducting device interacts with the spray gun, usually in a sealing way, by engaging a stop of the spray gun body.

In exemplary arrangements a mechanical guide may also have conical guide surfaces merging together in order to center the painting-agent conducting device and then to guide it by means of the mechanical guide to a defined point on the contact surface on the spray gun body. By this means, the manual introduction is facilitated and the exact positioning is improved.

In some arrangements a mechanical guide may, for example, include a mandrel, which is arranged in the application direction and may engage a bore. Some exemplary guides may be designed as a tongue and groove connection, which guides the painting-agent conducting device to the contact surface on the spray gun in the application direction like a rail. In some guide arrangements the mandrel may thereby lead into a narrowing bore and/or be conically designed itself in order to already position the painting-agent conducting device prior to the engagement with the spray gun body. A groove may also correspondingly narrow and/or a tongue may taper in the application direction, so that the painting-agent conducting device may be loosely guided on and only exactly positioned on the path, in order to ultimately be precisely guided via the mechanical guide on the spray gun responsive to movement of the painting-agent conducting device relative to the gun along the application direction.

In exemplary arrangements a mechanical guide may be designed such that it guides the already previously centered painting-agent conducting device on a predefined line to the stop on the body of the spray gun. A contact surface, which seals around a paint needle, then no longer has to take on a centering function. This is particularly relevant, if the sealing surface is comprised of a softer sealing material, which might be damaged during the centering. Even if the sealing surface has a structure, in particular like the elevations sliding into grooves described in WO 2016/138888 A1 (U.S. Pat. No. 10,870,120) and WO2018/109625A1 (U.S. Pat. No. 11,154,884), it may be beneficial if a centering is already achieved early on during the guiding, so that the elevations and depressions engage into each other well centered to one another and do not first have to effect a centering in order to only afterwards be able to interact with each other in a sealing way.

Even in arrangements in which the paint needle functions as a centering agent during engagement of the painting-agent conducting device on the spray gun, it may be useful if a particularly good centering is already achieved by the mechanical guide before the sealing surfaces designed around the paint needle engage. In such arrangements, the forces acting on the paint needle may be minimized.

In some arrangements in which a projecting element slides in a recess up to the stop of the painting-agent conducting device on the spray gun, it may then occur that contaminants are pushed into the recess with the projecting element. In some situations this can prevent sealing contact of the painting-agent conducting device on the spray gun. Therefore in exemplary arrangements the recess may be relatively more open and enlarged in such a way that contaminants may collect at the end of the recess or even be pushed into a space by the projecting element such that they do not prevent the contact of the painting-agent conducting device on the spray gun. In some arrangements, a ramp may be provided on the end of the recess, via which ramp the contaminants may be pushed out of the recess with a cloth, and in some arrangements even with the projecting element, in such a way that contaminants may be easily wiped off or otherwise removed.

The painting-agent holding cup releasably fixed on the spray gun may have a strainer or a flat strainer upstream of the color outlet in the flow direction. In some arrangements the flat strainer may be detachable or also non-detachable. In some exemplary arrangements the painting-agent conducting device which may alternatively be referred to herein as a paint delivery fitting, includes useful features. Useful exemplary arrangements also relate to a spray gun with a painting-agent conducting device, and an assembly including a spray gun, a painting-agent conducting device, and a paint or other spray material holding cup which is arranged on and in fluid connection with the painting-agent conducting device.

Further useful features and relationships will be apparent from the following Detailed Description and drawings which are part a part hereof.

### BRIEF DESCRIPTION OF DRAWINGS

FIG. 1 is a side view of an exemplary painting-agent conducting device.

FIG. 2 is an enlarged detail A from FIG. 1.

FIG. 3 is a front view of the exemplary painting-agent conducting device shown in FIG. 1.

FIG. 4 is a rear view of the exemplary painting-agent conducting device shown in FIG. 1.

FIG. 5 is a view from below of the exemplary painting-agent conducting device shown in FIG. 1.

FIG. 6 is a front perspective exploded partial view of a spray gun with the painting-agent conducting device shown in FIG. 1.

FIG. 7 is a perspective exploded partial side view of a spray gun with the painting-agent conducting device shown in FIG. 1.

FIG. 8 is a perspective exploded partial rear view of a spray gun with the painting-agent conducting device shown in FIG. 1.

FIG. 9 is a side view of a spray gun with an inserted and engaged painting-agent conducting device.

FIGS. 10 to 13 are further views of the spray gun assembly shown in FIG. 12.

FIG. 14 is a side view of an alternative painting-agent conducting device with a guide that includes a mandrel.

FIG. 15 is a perspective exploded side view of the painting-agent conducting device shown in FIG. 14 with a spray gun.

FIG. 16 is a rear perspective exploded view of another arrangement with a guide that includes a circumferential tongue.

FIG. 17 is an enlarged detail from FIG. 16 showing the exemplary circumferential tongue.

FIG. 18 is a partial side view of a spray gun body showing an oblique guide surface portion at the start of the engaging surface.

### DETAILED DESCRIPTION

The Figures show exemplary arrangements of a painting-agent conducting device that includes a mechanical guide that may have a web or a tongue as a projecting element which may be included on the painting-agent conducting device. This web may extend at the sides of the painting-agent conducting device, or in some arrangements it may also or alternatively be U-shaped or semi-circular. Cumulatively or alternatively, a mandrel, which engages in a corresponding opening or bore on a body of the spray gun, may also be provided on the rear side of the supply line which is alternatively referred to herein as a branch coupling portion. A projecting element, which engages in a respective recess in the painting-agent conducting device, may also be arranged on the spray gun.

In exemplary arrangements the alignment of the web, tongue, or mandrel is such that it guides and positions the painting-agent conducting device, and simultaneously holds it against forces in other directions, during insertion along a body axis up to engagement with a stop surface on the spray gun.

In exemplary arrangements by coordinating the guide, using single or multiple guides in parallel or at different locations, the painting-agent conducting device is guided and firmly retained in position in engagement with the spray gun body so that it requires little strength to prevent deformation or even breakage under daily use.

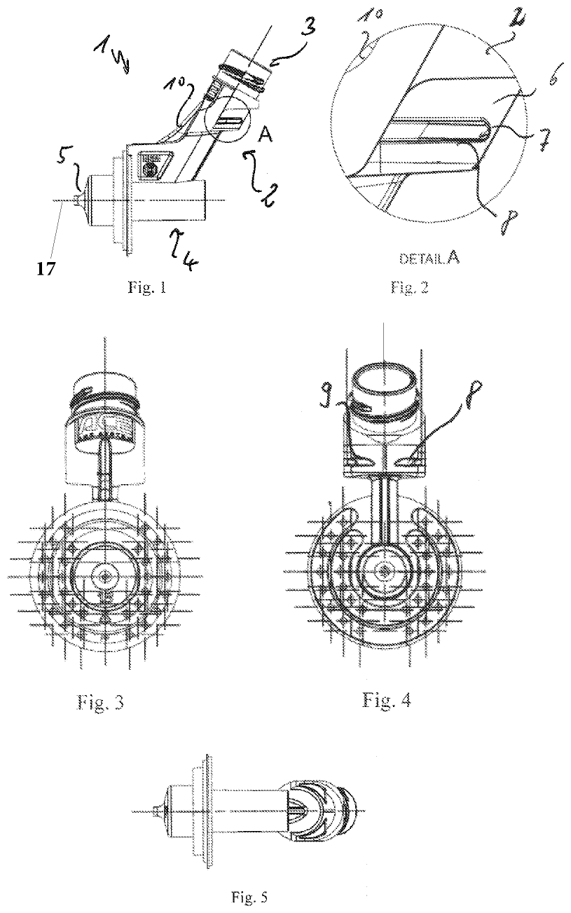

FIG. 1 shows an exemplary painting-agent conducting device 1 which is also referred to herein as a paint delivery fitting. The device includes a supply line 2 which is alternatively referred to as a branch coupling portion, and has a connection 3 for a painting-agent feed line (not shown). An outlet line 4 which is alternatively referred to as a central coupling portion leads painting-agent from supply line 2 to an outlet 5. Supply line 2 and outlet line 4 are arranged at an angle to each other, which in the exemplary arrangement is an obtuse angle relative to a portion of a body axis 17 that extends inward from the outlet 5 from which the painting agent is sprayed.

Detail A from FIG. 1, shown in FIG. 2, shows an exemplary mechanical guide 7, which extends parallel to axis 17 of outlet line 4, that is arranged on an exterior 6 of the supply line 2.

A projecting web 8 which is engageable in a slot or groove of the gun body is provided as shown in FIG. 2 as mechanical guide 7. In other arrangements a groove may also be provided instead of a web.

In other arrangements a mandrel or a bore (not shown) may also be correspondingly used as mechanical guide 7.

Mechanical guide 7 shown in FIG. 2 consists, in the exemplary arrangement, of two opposing webs 8 and 9. These sides and the webs lie on the exterior of both sides of supply line 2 on either transverse side of outlet line 4 and outlet 5.

A strengthening web 10, which connects the supply line and the outlet line to each other, is arranged in the angle vertex between supply line 2 and outlet line 4.

This exemplary web 10 is arranged in the vertex of the obtuse angle between supply line 2 and outlet line 4.

FIGS. 3, 4, and 5 show the exemplary painting-agent conducting device, shown in FIG. 1, from different sides.

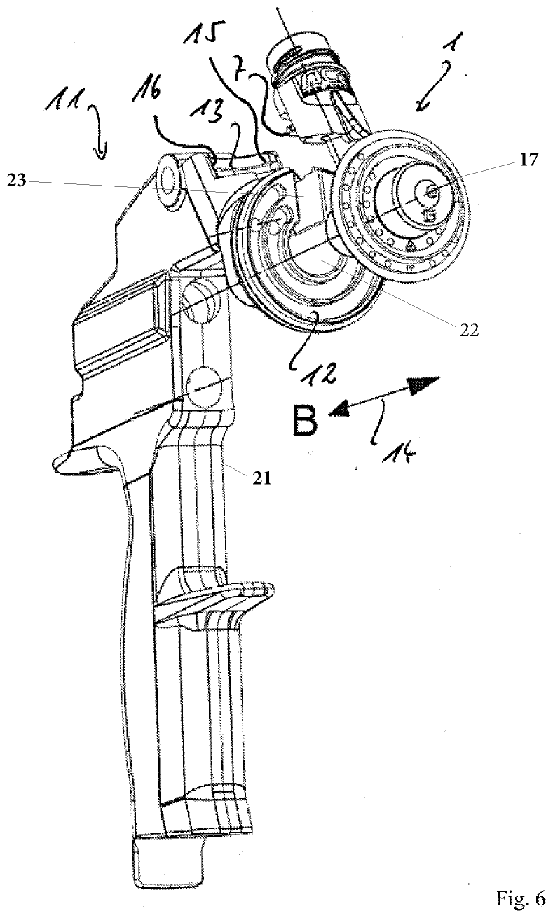

The exemplary arrangements relate to an apparatus including a spray gun 11, as it is shown, for example, in FIG. 6. This spray gun has a body 21 including a generally circular contact surface 12 for arranging painting-agent conducting device 1 and a counterpart 13 for interacting with mechanical guide 7 of painting-agent conducting device 1.

Exemplary painting-agent conducting device 1 is guided along the axis 17 which is also the line of movement of a paint needle within the outlet line 4. In engaging the device 1 with the gun body the device is guided along an application direction 14 onto contact surface 12 of spray gun 11. The device is movable along the axis 17 into engagement with the gun body until the painting-agent conducting device 1 strikes a stop for delimiting the movement of painting-agent conducting device 1 in the application direction 14. In an exemplary arrangement painting-agent conducting device 1 is movable adjacent contact surfaces 15, 16 for the spray gun body for holding painting-agent conducting device 1 on opposite sides against a movement perpendicular to application direction 14 and axis 17. Mechanical guide 7, which guides painting-agent conducting device 1 in the application direction 14 and holds it perpendicular to application direction 14, is provided for this purpose. In moving to the engaged condition with the spray gun the outlet line 4 of device 1 moves along the axis into a recess 22 in the body as shown and the supply line extends in a radially extending slot 23. An opposed end of the outlet line 4 from the outlet 5 extends in the recess 22 and includes the opening for receiving the needle therein.

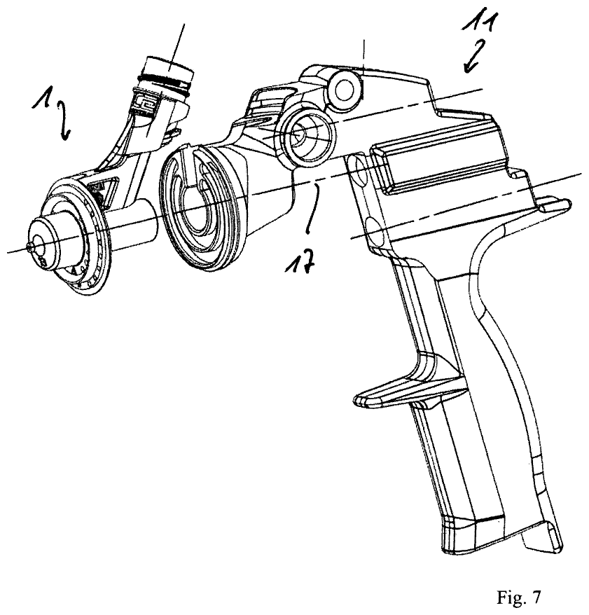

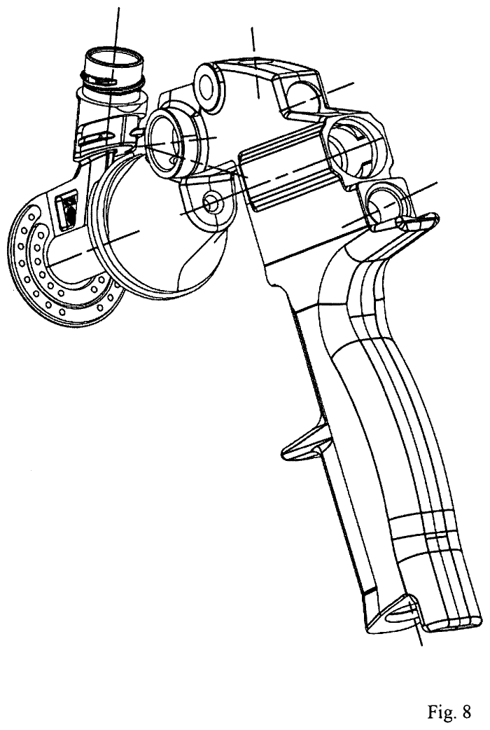

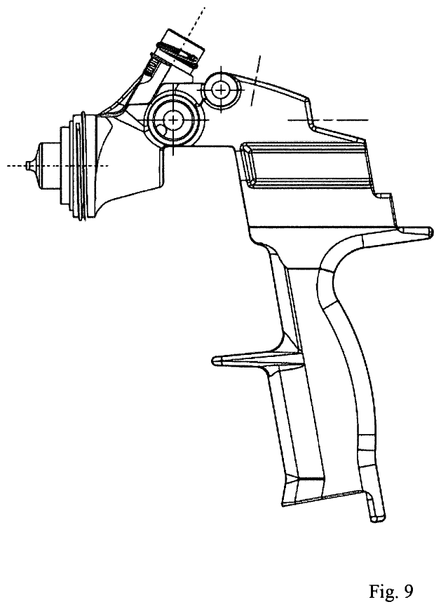

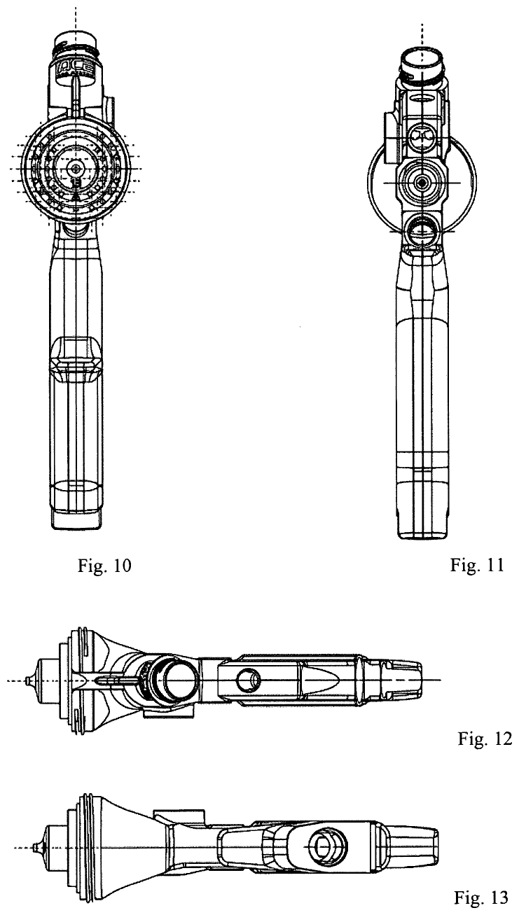

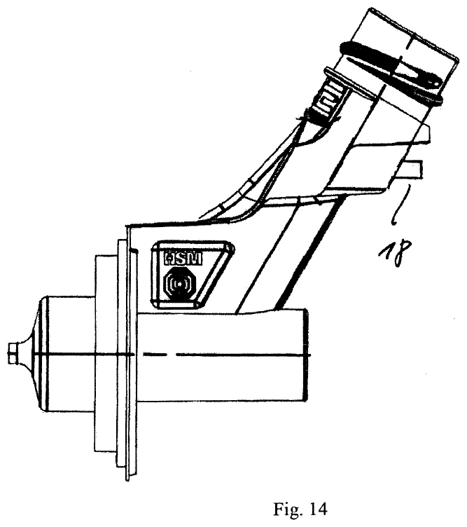

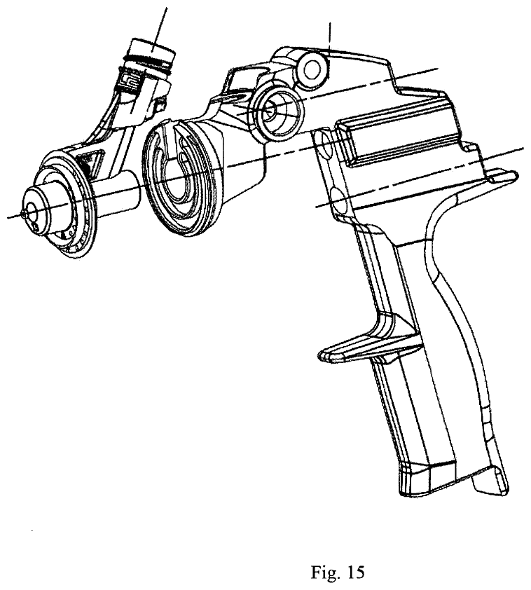

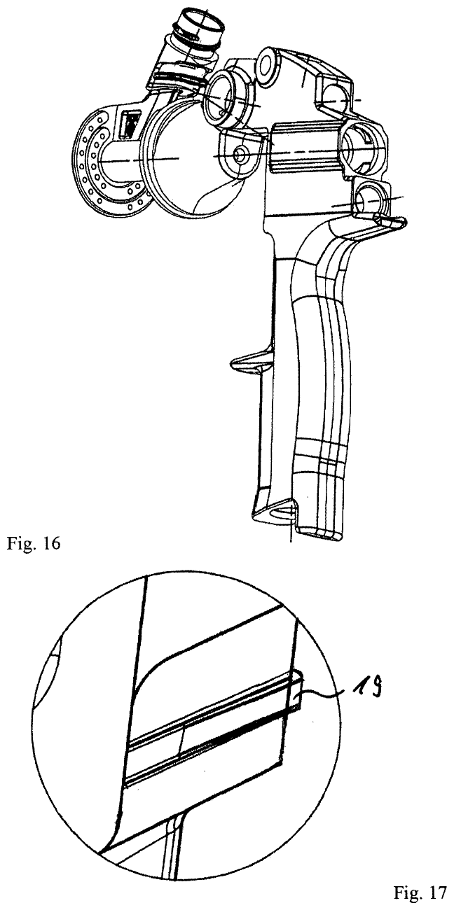

FIG. 7 shows the exemplary spray gun 11 and painting-agent conducting device 1 and which receives the paint needle which is linearly movable in the outlet line 4 along the axis.

An exemplary arrangement which includes a mandrel 18 for use as mechanical guide 7 is shown in FIG. 14. FIG. 17 shows an arrangement which includes a circumferential tongue 19 as mechanical guide 7. It should be noted that a projecting element on the painting-agent conducting device, which respectively interacts with a recess in the spray gun, may also be correspondingly configured as a projecting element on the spray gun with a recess on the painting-agent conducting device.

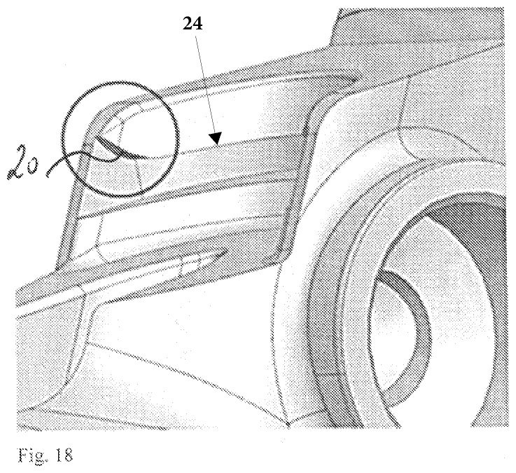

An exemplary arrangement with a guide engaging surface 24 includes an oblique guide surface portion 20 at the start of the surface 24 which serves to direct a guide projection on the exemplary paint delivery fitting below the surface 24 is shown in FIG. 18. This facilitates the insertion of the guide into engagement with the gun and hold the paint delivery fitting in the proper orientation relative to the gun body.

Thus the exemplary arrangements achieve improved operation, eliminate difficulties encountered in the use of prior devices and systems and attain the useful results described herein.

In the foregoing description, certain terms have been used for brevity, clarity and understanding. However, no unnecessary limitations are to be implied therefrom because such terms are used for descriptive purposes and are intended to be broadly construed. Moreover the descriptions and illustrations herein are by way of examples and the new and useful features are not limited to the features shown and described.

It should be understood that the features and/or relationships associated with one exemplary arrangement can be combined with features and/or relationships from another exemplary arrangement. That is, various features and/or relationships from various arrangements can be combined in further arrangements. The new and useful scope of the disclosure is not limited to only the arrangements shown or described herein.

Having described the features, discoveries and principles of the exemplary arrangements, the manner in which they are constructed and operated and the advantages and useful results attained, the new and useful features, devices, elements, arrangements, parts, combinations, systems, equipment, operations, methods, processes and relationships are set forth in the appended claims.

1-10. (canceled)

11. Apparatus comprising:
a painting-agent conducting device, wherein the painting-agent conducting device is configured for use with a spray gun, and
is releasably engageable with the spray gun,
wherein the painting-agent conducting device includes
a supply line,
a connection to the supply line, and
an outlet line, wherein the outlet line extends from the supply line to an outlet, wherein the supply line and the outlet line are arranged at an angle to each other,
a mechanical guide, wherein the mechanical guide
extends parallel to the outlet line,
is arranged on an exterior of the supply line, and
is configured to guide the painting-agent conducting device on a path to a stop on the spray gun during engagement of the painting-agent conducting device with the spray gun.

12. The apparatus according to claim 11
wherein the mechanical guide comprises at least one of a web or a groove.

13. The apparatus according to claim 11
wherein the mechanical guide comprises at least one of a mandrel or a bore.

14. The apparatus according to claim 11
wherein portions of the mechanical guide are arranged on opposite sides on the exterior of the supply line.

15. The apparatus according to claim 11
and further comprising:
a web, wherein the web connects the supply line and the outlet line and extends in a vertex of the angle between the supply line and the outlet line.

16. The apparatus according to claim 11
wherein the angle is an obtuse angle,
and further comprising a web, wherein the web connects the supply line and the outlet line and extends in a vertex of the angle between the supply line and the outlet line.

17. The apparatus according to claim 11
and further including
the spray gun,
wherein the spray gun includes a counterpart, wherein the counterpart interacts with the mechanical guide.

18. Apparatus comprising:
a spray gun,
a painting-agent conducting device, wherein the painting-agent conducting device is releasably engageable with the spray gun,
wherein the painting-agent conducting device includes
an outlet line, wherein the outlet line extends along an axis,
wherein the outlet line is configured to deliver a painting-agent from an outlet along the axis,
a guide, wherein the guide extends parallel to the axis and in an opposed direction relative to the outlet,
wherein the spray gun includes
a pair of disposed contact surfaces, wherein the contact surfaces are configured to operatively engage the guide of the painting-agent conducting device on opposed sides,
wherein the disposed contact surfaces enable movement of the painting-agent conducting device along the axis with the guide intermediate of the contact surfaces and prevent relative movement of the guide and the painting-agent conducting device in a direction transverse to the axis,
a stop, wherein the stop limits engaging movement of the painting-agent conducting device along the axis into engagement with the spray gun.

19. The apparatus according to claim 18
wherein the gun includes a paint needle, wherein the paint needle extends along the axis,
wherein the guide extends in a guide plane, wherein the guide plane does not intersect with the axis.

20. The apparatus according to claim 18
and further including a cup,
wherein the cup is configured to hold a painting-agent,
wherein the cup is releasably engageable with the painting-agent conducting device.

21. Apparatus comprising:
a paint spray gun, wherein the paint spray gun includes a body,
a paint delivery fitting, wherein the paint delivery fitting is releasably engageable with the body,
wherein the paint spray gun includes
an axially extending body recess,
a radially extending body slot, wherein the radially extending body slot extends radially outward from the body recess,
a pair of disposed facing contact surfaces, wherein the contact surfaces are disposed radially outward of the body slot,
a stop, wherein stop extends transverse of the contact surfaces,
wherein the paint delivery fitting includes
a central coupling portion,
wherein in an operative position of the paint delivery fitting the central coupling portion extends along the body axis and in engaged relation with the gun body,
includes an outlet configured to deliver paint at an outer axial end, and a needle receiving opening at an axial end opposed of the outlet,
a branch coupling portion, wherein in the operative position the branch coupling portion
extends radially outward from the central coupling portion and in the body slot,
includes an outer connection configured to receive paint therein,
extends at an obtuse angle relative to a body axis portion that extends inward from the outlet,
is configured to deliver paint from the outer connection to the central coupling portion, and
includes a guide, wherein in the operative position the guide
extends parallel to the body axis and radially outward thereform,
extends intermediate of the contact surfaces
is in abutting engagement with the stop,
wherein in the operative position the paint delivery fitting
is prevented from being moved relative to the body in a direction perpendicular to the body axis, and
is separable from the gun by movement along the body axis in a direction away from the stop.

22. The apparatus according to claim 21
wherein the outer connection is configured to be releasably engageable with a paint cup,
wherein in the operative position the paint cup extends above the gun body.

23. The apparatus according to claim 21
wherein the branch delivery portion further includes at least one external web or groove,
wherein in the operative position each web or groove
is disposed radially above the body axis, and
is in engaged relation with a respective groove or web in the gun body.

24. The apparatus according to claim 21
wherein the branch delivery portion further includes at least one external web or groove,
wherein the operative position each web or groove
is disposed radially above the body axis,
extends in a direction transverse of the radial direction, and
is in engaged relation with a respective groove or web of the gun body.

25. The apparatus according to claim 21
wherein the paint delivery fitting includes one of a mandrel or a bore,
wherein in the operative position the mandrel or the bore is in engaged relation with the respective bore or mandrel of the gun body.

26. The apparatus according to claim 21
wherein in the operative position the guide extends below a guide engaging surface on the gun body,
wherein the guide engaging surface includes an oblique guide surface portion,
wherein in movement of the paint delivery fitting along the body axis toward the operative position, guide engagement with the oblique guide surface portion causes the guide to be directed below the guide engaging surface.

27. The apparatus according to claim 21
and further comprising:
a strengthening web, wherein the web extends in a vertex of the obtuse angle.

28. The apparatus according to claim 21
wherein the guide extends in a guide plane, wherein the guide plane does not intersect with the body axis.

29. The apparatus according to claim 21
wherein the gun body includes a circular contact surface, wherein the radially extending body slot extends in the contact surface,
wherein in the operative position of the paint delivery fitting, the paint delivery fitting is in abutting engagement with the contact surface.

30. The apparatus according to claim 21
wherein the paint spray gun includes a movable needle,
wherein the needle is selectively movable along the body axis within the central coupling portion.
